(19) United States
(12) Patent Application Publication
(10) Pub. No.: US 2026/0264841 A1
(43) Pub. Date: Sep. 10, 2026

(54) ROTOR HUB FOR PROPELLER-DRIVEN AIRCRAFT, AND ASSEMBLY COMPRISING SUCH A ROTOR HUB

(71) Applicant: Maxon International AG, Sachseln (CH)

(72) Inventors: Luise LOESKOW, Alpnach-Dorf (CH); Marco SICHER, Beckenried (CH); Roman MEIER,, lnwil (CH)

(73) Assignee: Maxon International AG, Sachseln (CH)

(21) Appl. No.: 19/165,517

(22) PCT Filed: Mar. 18, 2024
(86) PCT No.: PCT/EP2024/057168

§ 371 Date: Sep. 15, 2025

(30) Foreign Application Priority Data
Mar. 16, 2023 (EP) 23162384.4

(51) Int. Cl. B64C 11/10; B64C 11/28

(52) U.S. Cl. CPC B64C 11/10; B64C 11/28

(57) ABSTRACT

The present disclosure relates to a rotor hub, in particular for propeller-driven aircraft. The rotor hub has a hole for receiving a drive shaft. The hole has an internal thread which is designed to interact with an external thread of the drive shaft and to detachably connect the rotor hub to the drive shaft. The hole also has an annular groove for receiving an O-ring that is suitable for inhibiting a relative movement between the rotor hub and the drive shaft.

### CROSS-REFERENCE TO RELATED APPLICATIONS

The subject application claims priority to and the benefit of PCT Patent App. No. PCT/EP 2024/057168, filed Mar. 18, 2024 and entitled “ROTOR HUB FOR AIRCRAFT WITH A PROPELLER DRIVE, AND ASSEMBLY COMPRISING A ROTOR HUB OF THIS KIND” and to European Patent App. No. 23162384.4, filed Mar. 16, 2023, and entitled “ROTOR HUB FOR AIRCRAFT WITH A PROPELLER DRIVE, AND ASSEMBLY COMPRISING A ROTOR HUB OF THIS KIND,” and the entire contents of both of these applications are herein incorporated by reference.

### BACKGROUND

### 1. Field

The present disclosure relates to a rotor hub for an aircraft with a propeller drive.

### 2. Related Art

A rotor hub of the type in question has a hole for receiving a drive shaft, the hole comprising an internal thread which is designed to interact with an external thread of the drive shaft and to detachably connect the rotor hub to the drive shaft.

Rotor hubs of the type in question are mainly used in the field of unmanned aircraft. The connection of the rotor hub to the drive system is an important aspect and can generally be designed to be detachable or non-detachable. With detachable connections, for example, the rotor hub can be attached directly to the drive shaft by means of a central thread. Typically, in this case, the thread direction is designed in such a way that the rotor hub is tightened during the acceleration process of the drive shaft, thus supporting the frictional connection between the drive shaft and the rotor hub. Alternatively, detachable connections that tighten during rotor operation can be realized by fastening elements in the form of two- or three-dimensional shapes that are complementary to the rotor hub and shaft and interact via a suitable fitting connection.

DE202014010962 describes various embodiments of the attachment of a rotor hub to a drive shaft.

However, the types of fastening known from the prior art are not optimal, since the fastening of the rotor hub to the shaft is designed to be self-tightening during operation, but without further safety features such connections can become loose due to external influences such as vibrations or abrupt load changes, thus endangering the functional reliability of the drive.

### SUMMARY

The object of the present disclosure is therefore to provide a rotor hub which is characterized by increased operational reliability while maintaining a consistently compact design.

The object is achieved by the hole having an annular groove for receiving an O-ring which is suitable for inhibiting the relative movement between the rotor hub and the drive shaft.

The present disclsoure is particularly relevant for the field of propeller-driven unmanned flying objects. These include, for example, drones with a horizontal arrangement of the propellers, but also fixed-wing aircraft with a vertically aligned propeller.

According to an advantageous embodiment of the present disclosure, the hole has a first hole section, the first hole section comprising the annular groove, and the hole has a second hole section, the second hole section comprising the internal thread, and the internal diameter of the first hole section being larger than the nominal diameter of the internal thread. The design of the diameters of the hole sections depends on how the two hole sections are arranged relative to a screw-in direction. It is therefore also conceivable for the nominal diameter of the internal thread to be larger than the diameter of the first hole section surrounding the annular groove.

According to a further advantageous embodiment of the present disclosure, the annular groove and the internal thread are designed to be spaced apart from one another in the axial direction. Advantageously, the annular groove is not arranged within the internal thread. However, designs are also conceivable in which the annular groove and an O-ring arranged within the annular groove are arranged in the region of the internal thread.

According to a further advantageous embodiment of the present disclosure, the hole has a screw-in direction and the annular groove is arranged in front of the internal thread in the screw-in direction. This arrangement offers the advantage that within the first hole section surrounding the annular groove a centering means can be provided which simplifies the screwing-in process step.

According to a further advantageous embodiment of the present disclosure, the rotor hub is a propeller hub and has at least one receiving element for fastening a rotor blade. However, the rotor hub can also have two, three or more receiving elements for a rotor blade, depending on the type of flying object to be equipped and the number of rotor blades required.

According to a particularly advantageous embodiment of the present disclosure, the rotor hub is part of an assembly comprising an O-ring, the O-ring being arranged in the annular groove, a drive shaft, the drive shaft having a drive shaft axis and an external thread which is configured to interact with the internal thread of the rotor hub and to detachably connect the drive shaft to the rotor hub.

According to a further advantageous embodiment of the present disclosure, the annular groove of the rotor hub has a width and a depth and the O-ring is designed and positioned in the annular groove in such a way that, in the installed state, the rotor hub and the drive shaft come into frictional contact.

The advantage of the rotor hub according to the disclosure is particularly evident in its installation with an O-ring and a drive shaft. Due to the position of the O-ring in the annular groove and its corresponding dimensioning, the O-ring is in frictional contact with the drive shaft and in positive contact with the rotor hub when the drive shaft and rotor hub are installed. The frictional contact of the O-ring with the drive shaft ensures that the relative movement between the rotor hub and the drive shaft is inhibited. The advantage of using an O-ring is that the O-ring inhibits the relative movements between the rotor hub and the drive shaft in all operating conditions, but does not limit or prevent the relative movements. In addition, assembly and disassembly of the rotor hub and drive shaft can also be carried out with the O-ring installed.

According to a further advantageous embodiment of the present disclosure, the drive shaft comprises a functional section which forms a clearance fit with the first hole section of the rotor hub. The clearance fit between the first hole section of the rotor hub and the functional section of the drive shaft ensures clean centering and alignment of the drive shaft with the rotor hub when screwing-in. This makes it possible to minimize imbalances and to ensure smooth operation of the assembly.

According to a further advantageous embodiment of the present disclosure, the rotor hub has a rotor axis and a rotor hub rotation direction corresponding to the driven state, and the thread direction of the rotor hub and drive shaft is designed such that when accelerated by a drive system in the rotor hub rotation direction, the rotor hub is tightened on the drive shaft.

According to a further advantageous embodiment of the present disclosure, the O-ring consists of a polymer. The advantage of a polymer is that the material is flexible and deformable. The O-ring is arranged in the annular groove of the rotor hub and is designed to inhibit the relative movements between the rotor hub and the drive shaft. This requires frictional contact between the O-ring and the drive shaft. The O-ring and the annular groove are advantageously dimensioned in such a way that the O-ring has a greater extension in the radial direction than the annular groove. However, the width of the annular groove, i.e. the extension in the axial direction, should be greater than the width of the O-ring. When the drive shaft is screwed into the rotor hub, the drive shaft presses the O-ring radially outwards, the O-ring being deformed and the material of the O-ring expanding in the direction of the width of the annular groove. The O-ring is therefore positively connected to the rotor hub and frictionally connected to the drive shaft.

According to a particularly advantageous embodiment of the present disclosure, the assembly comprises at least one rotor blade which is mounted in the receiving element so as to be rotatable about a rotor blade axis, the rotor blade axis being aligned substantially parallel to the drive shaft axis, the rotor blade having an operating position, and the rotor blade in the operating position being aligned substantially radially to the drive shaft axis and radially to the rotor blade axis, and the rotor blade having a storage position, and the rotor blade in the storage position being rotated about the rotor blade axis opposite the operating position. The rotor blade can be mounted so as to be rotatable such that the rotor blade can be folded into the storage position and that the rotor blade can be brought into the operating position, for example as a result of the centrifugal force caused by the rotation of the rotor hub.

The fact that the rotor blade axis is aligned substantially parallel to the drive shaft axis means, in the context of the exemplary embodiment described, that the axes have an offset of at most 5°, preferably at most 1° and particularly preferably not more than 0.1° from one another.

Rotatably mounted rotor blades have the advantage that they can be folded into a storage position when not in use, and thus be accommodated in a space-saving manner. This arrangement also makes it possible for the rotor blades not to have to be manually moved into the operating position before flight operation, but to move themselves into the operating position as a result of centrifugal force.

However, during start-up, the inertia of the rotor blades can cause said rotor blades to over-rotate, meaning they continue to rotate from their respective storage position to beyond their operating position. At corresponding accelerations, over-rotating is limited only by the rotor blade striking the rotor hub. Depending on the design of the rotor hub, the rotor blade striking the rotor hub can cause damage to both of these components. In unfavorable cases, this creates a notch on the rotor blade where the rotor can become jammed, disrupting or even preventing the rotor blades from being aligned in the operating position.

According to a further advantageous embodiment of the present disclosure, a locking device is provided to hold the rotor blades in the operating position or in the storage position. The locking device is provided on the rotor hub and on the rotor blades. The locking device comprises, for example, a recess on the rotor hub and a knob-like element on the rotor blade. The recess can, for example, be arranged on the rotor hub as a hole between the rotor axis and the rotor blade axis. The recess can also be arranged on the rotor hub as a cutout on the opposite side of the rotor axis, towards the rotor blade. In this case, the rotor blade can have a raised or knob-like element. The knob-like element is arranged on the rotor blade at the end close to the rotor hub. The recess and the knob-like element work together in a form-fitting manner and hold the rotor blade in the operating position. By the knob-like element and the recess latching together, the rotor blade is fixed relative to the rotor hub in the operating position, but can be released again with appropriate force and, for example, folded into the storage position. This locking device makes it possible for the rotor blades to be unfolded and fixed in a suitable position, as well as folded into the storage position. By using rotatably mounted rotor blades, which can be folded into a storage position when not in use, space-saving storage of the rotor blades is thus possible.

According to a further advantageous embodiment of the present disclosure, a further embodiment of the locking device is provided. The locking device consists, for example, of an end of the rotor hub that tapers towards the rotor blade. The rotor blade has at least two raised or knob-like elements which, in an operating position, rest against the surfaces of the narrow end of the rotor hub. These knob-like elements enclose the narrow tapering end of the rotor hub on both sides and thus achieve a latching effect of the rotor blades in the operating position, which can be released again with appropriate force. This locking device makes it possible for the rotor blades to be unfolded and fixed in the operating position, as well as folded into the storage position when not in use.

According to a particularly advantageous embodiment of the present disclosure, it is therefore provided that the rotor blade has a first rotor direction of rotation about the rotor blade axis and a second rotor direction of rotation opposite the first rotor direction of rotation, and that the rotor blade has an end near the rotor hub and an end remote from the rotor hub, and the rotor hub having a stop surface which interacts with the end of the rotor blade near the rotor hub in such a way that a deflection of the rotor blade in the second rotor direction of rotation is limited to a maximum of 90° and preferably to a maximum of 85° relative to the operating position of the rotor blade.

The design of the stop surface ensures that the rotor blades are stopped by a defined stop when they over-rotate, the contact between the stop surface and the end of the rotor blade near the rotor hub being designed in such a way that neither component suffers damage. The end of the rotor blade near the rotor hub refers to the region of the rotor blade that is closer to the rotor hub when installed, and the end remote from the rotor hub refers to the other region that is further away from the rotor hub. The design of the stop surface is therefore essential for reliable operation of the rotor hub according to the disclosure.

According to a further advantageous embodiment of the present disclosure, the stop surface is configured such that a deflection of the rotor blade in the second rotor rotation direction of at least 75° and preferably of at least 80° relative to the operating position of the rotor blade is permitted.

The stop surface allows the rotor blade to be folded into a storage position even in the second direction of rotor rotation. The movement of the rotor blade in the first rotor rotation direction is not restricted by the stop surface, so that the maximum angle of rotation of the rotor blade about the rotor blade axis and relative to the operating position in the first rotor rotation direction is greater than in the second rotor rotation direction.

When the assembly is not in use, it may be advantageous to pivot the rotor blades so that they are aligned approximately parallel to each other in order to be able to store the assembly in a space-saving manner. For this purpose, it is necessary for the rotor blades to be allowed sufficient deflection in both rotor directions of rotation.

The particular advantage of the described embodiment of the rotor hub is therefore that the stop surface ensures reliable contact between the rotor hub and the rotor blade when the rotor blade is over-rotated, and at the same time ensures sufficient freedom of rotation of the rotor blade for space-saving storage.

According to a further advantageous embodiment of the present disclosure, sensors are provided for detecting the rotor position and/or the motor temperature. In order to ensure a suitable position of the rotor blades in the switched-off operating state, a sensor can be used to determine the exact position of the drive shaft or motor and to align the rotor blades accordingly to protect them from damage. For example, the rotor blades can be damaged during a landing of a fixed-wing aircraft due to an unintentional vertical position of the rotor blades, whereas the rotor blades are protected when the propeller is in a horizontal position. Furthermore, in the case of a multicopter, the alignment of the propellers after landing can, for example, automatically cover the multicopter in a charging station, whereby the alignment of the rotor blades prevents damage. The sensor for determining the rotor position can be, for example, a Hall sensor or an optical sensor. It is also possible to detect the position of the rotor by means of the commutation controller. In this case, the rotor can be actively braked. In the event of such an abrupt load change, the propeller may become detached from the rotor hub, so in this embodiment it is advantageous to secure the rotor hub by means of an O-ring, which is positively connected to the rotor hub and frictionally connected to the drive shaft. A temperature sensor may be provided to counteract damage to the O-ring. The state of the motor can also be monitored by means of a temperature sensor.

### BRIEF DESCRIPTION OF THE DRAWINGS

An exemplary embodiment of the present disclosure is explained in more detail below with reference to drawings, in which:

FIG. 1: is a sectional view of a rotor hub according to the disclosure,

FIG. 2: is a perspective view of a rotor hub according to the disclosure,

FIG. 3: is a sectional view of an assembly,

FIG. 4: shows a rotor hub according to the disclosure with rotor blade,

FIG. 5: shows a rotor hub according to the disclosure with two rotor blades in the operating position,

FIG. 6: shows a rotor hub according to the disclosure with two rotor blades in the storage position,

FIG. 7: shows a rotor hub according to the disclosure with two rotor blades in the operating position,

FIG. 8: shows a locking device of a rotor blade on the rotor hub in a first embodiment,

FIG. 9: shows a locking device of a rotor blade on the rotor hub in a second embodiment,

FIG. 10: shows a locking device of a rotor blade on the rotor hub in a third embodiment, and

FIG. 11: is a schematic representation of an assembly comprising sensors for detecting the rotor position and/or motor temperature.

### DETAILED DESCRIPTION OF THE ENABLING EMBODIMENTS

In the following embodiments, like parts are denoted by like reference signs. If a figure contains reference signs that are not discussed in detail in the corresponding figure description, reference is made to preceding or subsequent figure descriptions.

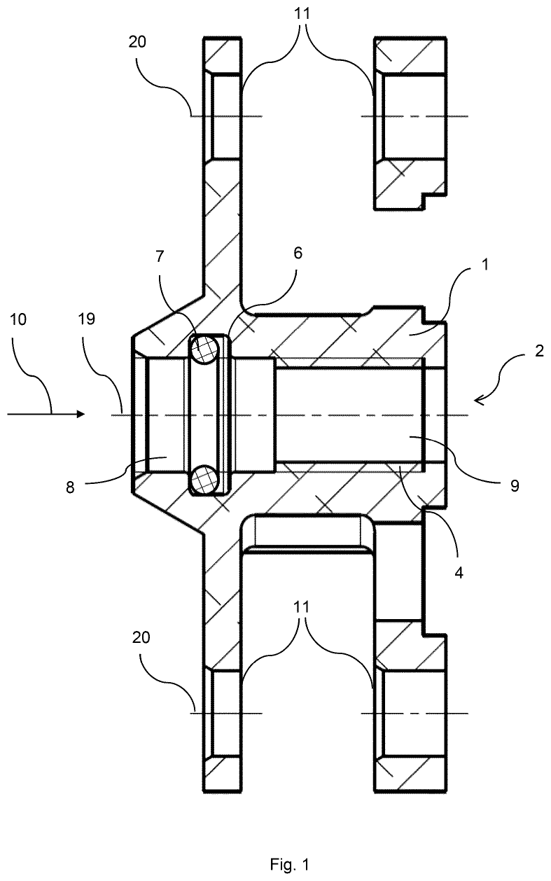

FIG. 1 shows the sectional view of a rotor hub 1 according to the disclosure with a hole 2. The hole 2 is provided with an internal thread 4 and for this purpose has an annular groove 6. The annular groove 6 is formed in the first hole section 8, whereas the internal thread 4 is made in the second hole section 9. It can also be clearly seen that the annular groove 6 and the internal thread 4 are spaced apart from one another in the axial direction and that the internal diameter of the first hole section 8 is slightly larger than the nominal diameter of the internal thread 4. Furthermore, the embodiment of the rotor hub 1 according to the disclosure shown here has two receiving elements 11, each with a rotor blade axis 20 for one rotor blade 12 in each case. For screwing the rotor hub 1 according to the disclosure to a drive shaft 3, a screw-in direction 10 is provided, the first hole section 8 with the annular groove 6 being formed in front of the second hole section 9 in the screw-in direction 10.

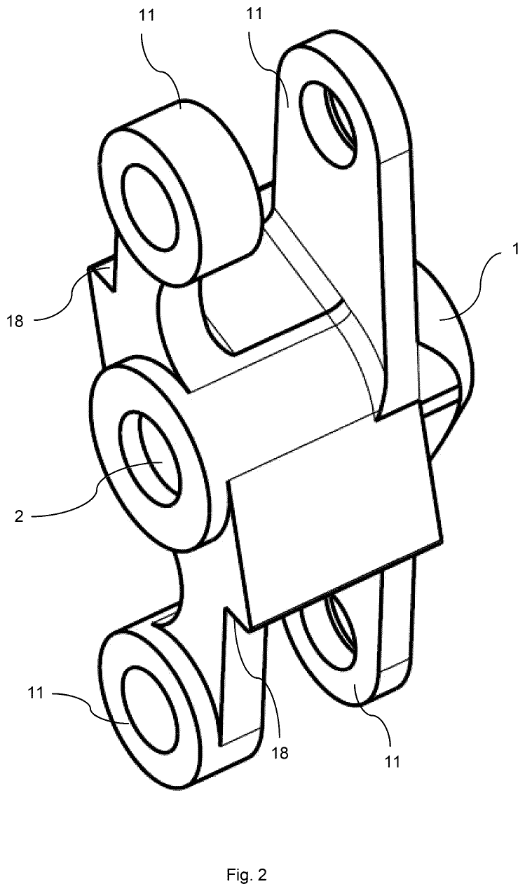

FIG. 2 shows a three-dimensional representation of the rotor hub 1 according to the disclosure. The two stop surfaces 18 formed on the rotor hub 1 according to the disclosure can be clearly seen.

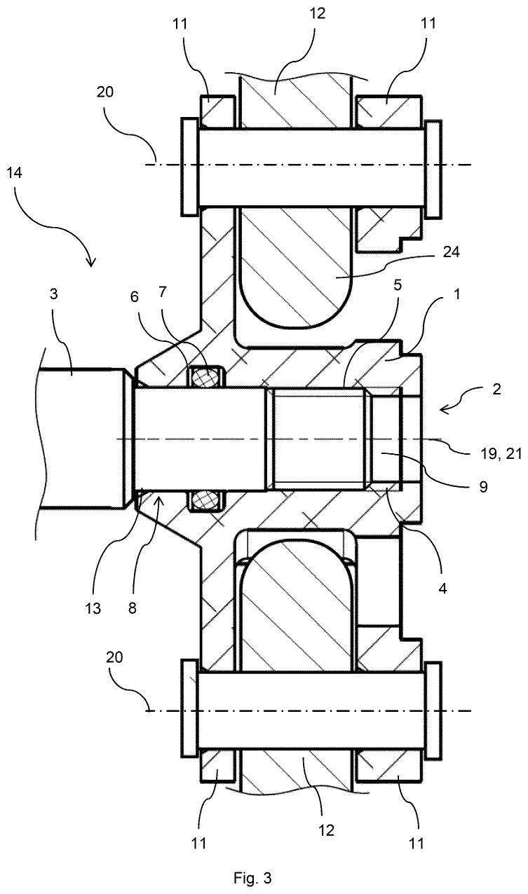

FIG. 3 shows an assembly 14 comprising the rotor hub 1 according to the disclosure, an O-ring 7, a drive shaft 3 with a drive shaft axis 21, which in the embodiment shown corresponds to the rotor axis 19, and two rotor blades 12. The drive shaft 3 is screwed to the rotor hub 1 according to the disclosure, the O-ring 7 being installed in the annular groove 6 and being in frictional contact with the functional section 13 of the drive shaft 3. The first hole section 8 and the functional section 13 of the drive shaft form a clearance fit. In each of the two receiving elements 11, a rotor blade 12 is mounted so as to be rotatable about the rotor blade axis 20. It can be clearly seen that the rotor blade axis 20 is aligned parallel to the rotor axis 21 or parallel to the drive shaft axis 19.

The design of the rotor hub 1 according to the disclosure makes possible a repeatable and exact installation of the drive shaft 3 in the rotor hub 1 thanks to the existing clearance fit between the drive shaft 3 and the rotor hub 1. A further contribution to reliable operation is made by the installed O-ring 7, which counteracts the detachment of the rotor hub 1 and drive shaft 3 in every operating state.

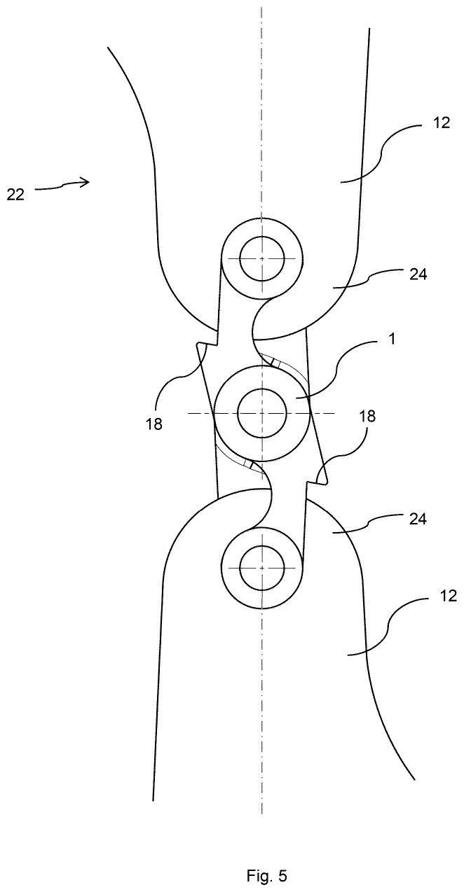

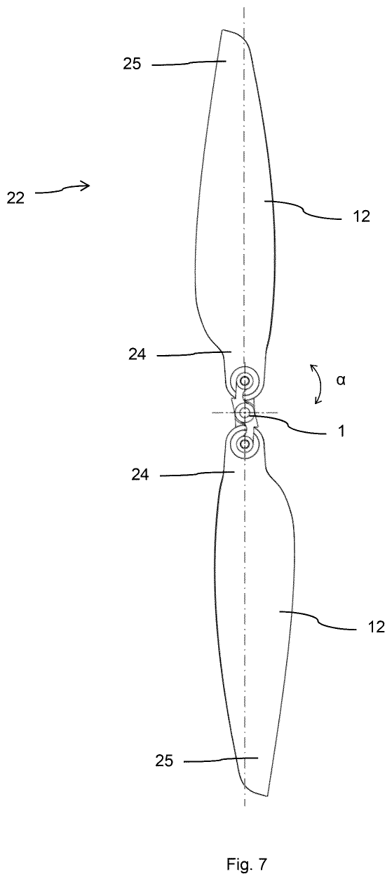

FIG. 5 and FIG. 7 show a rotor hub 1 according to the disclosure with two rotor blades 12 in the operating position 22. The rotor blades 12 are aligned radially to the drive shaft axis 21 and the rotor blade shaft 20 pointing into the blade plane, the two rotor blades 12 in turn being oriented at approximately 180° to each other and pointing vertically upwards or vertically downwards in the examples shown. It can also be clearly seen that the stop surface 18 in the operating position 22 does not interact with the end 24 of the rotor blade 12 near the rotor hub.

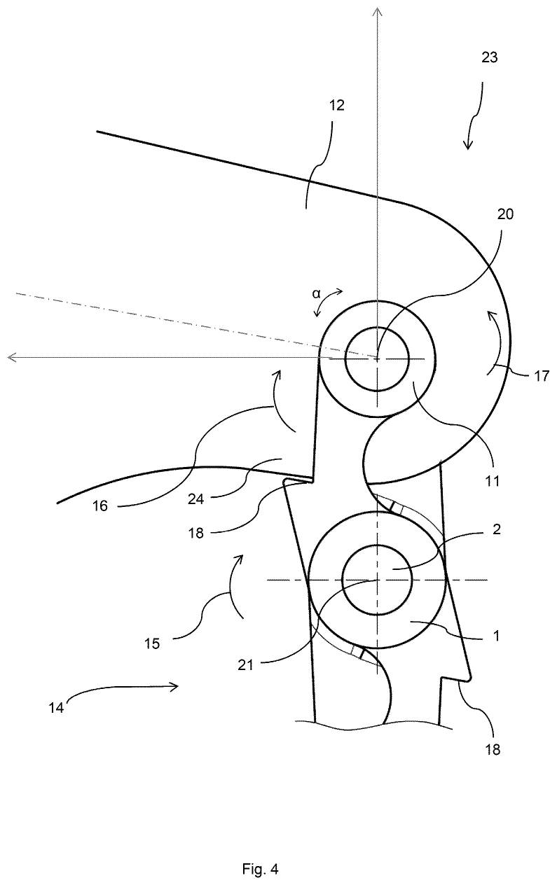

FIG. 4 shows the interaction of the stop surface 18 with the end 24 of the rotor blade 12 near the rotor hub. This situation arises, for example, when the rotor hub 1 accelerates about the rotor axis 19. The rotor hub 1 then rotates in the rotor hub rotation direction 15 and the rotor blade 12 due to its inertia rotates in the direction of the second rotor rotation direction 17, the end 24 of the rotor blade 12 near the rotor hub striking the stop surface 18 and being prevented by this from over-rotating. The angle of rotation of the rotor hub a relative to the operating position 22 is approximately 80° in the embodiment shown.

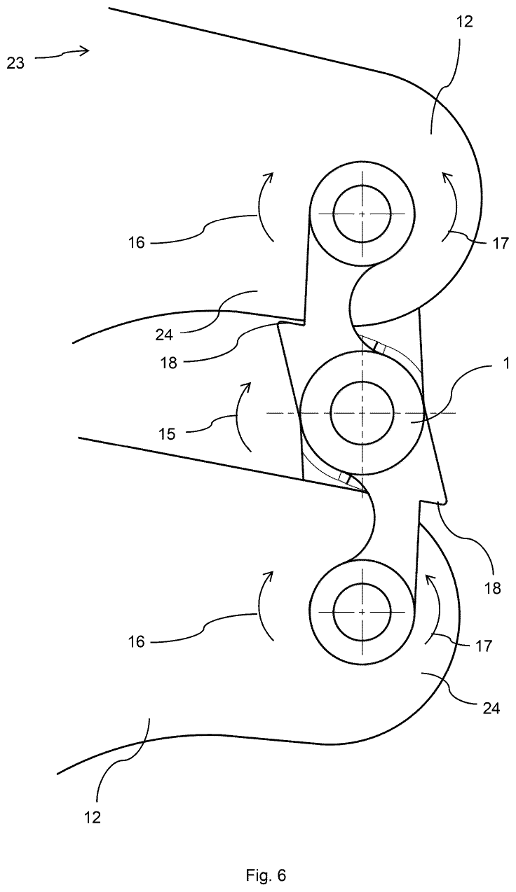

Another example of the contact or abutment of the end 24 near the rotor hub against the stop surface 18 is shown in FIG. 4. It may be advantageous if both rotor blades 12 are aligned parallel to each other in the storage position 23. In this folded position, rotor blades can be stored in a space-saving manner, while at the same time the rotor can be quickly used again. For this purpose, it is necessary that both rotor blades 12 have sufficient freedom of rotation in both rotor rotation directions 16, 17. One of the rotor blades 12, the upper one in the example shown, is rotated in the second rotor rotation direction 17, whereas the other rotor blade 12 in each case, the lower one in the example shown, is rotated in the first rotor rotation direction 16. It is also clearly visible that due to the design of the rotor hub 1 and in particular due to the contact surface 18, the angle of rotation a in the first rotor rotation direction 16 is greater than in the second rotor rotation direction 17. As a result, a parallel alignment of the two rotor blades 12 could also be achieved by the upper rotor blade 12 in the illustration in FIG. 6 having a smaller angle of rotation a and consequently no longer resting against the stop surface 18, and at the same time the lower rotor blade 12 in FIG. 6 is deflected even further in the first rotor rotation direction 16 until both rotor blades 12 are aligned approximately parallel to one another.

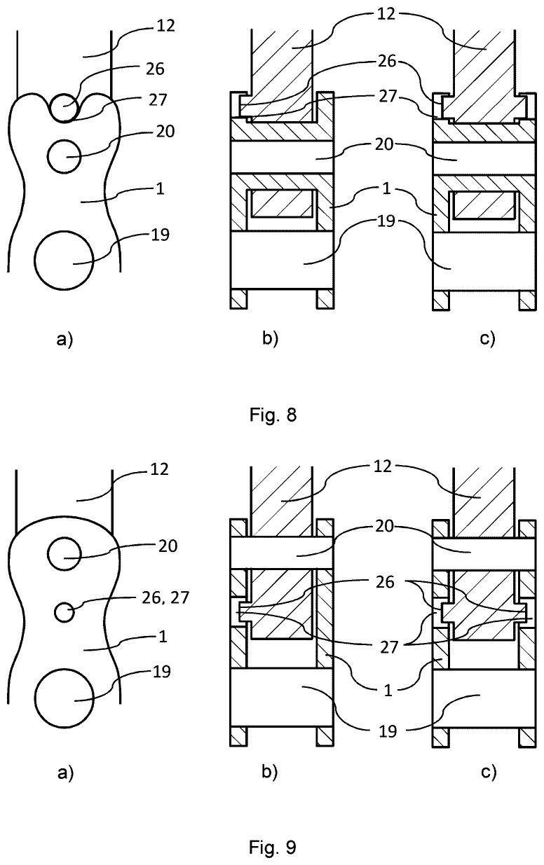

FIGS. 8-10 show locking devices of a rotor blade 12 on the rotor hub 1 in various embodiments. The rotor blades 12 are aligned in a defined position relative to the rotor hub 1 by means of a locking device. The locking device can be designed in different ways. The locking device has, for example, a knob-like element 26 and a recess 27. The locking device may also have a bulge 28 and two knob-like elements 26. In all embodiments, the rotor blade 12 is held in an operating position 22 by the locking device. With a certain force tangential to the rotor blade axis 20, the rotor blade 12 can be folded into the storage position. In this case, the locking devices can be designed or arranged in such a way that the rotor blades 12 are also held in the storage position relative to the rotor hub 1.

A first embodiment of a locking device is shown in FIGS. 8a-c. The locking device has a recess 27 on the rotor hub 1. The recess 27 is a cutout. The recess on the rotor hub 1 has its deepest point on a straight line passing through the center of the rotor axis 19 and the rotor blade axis 20. When the rotor blade 12 is in the operating position 22, the rotor blade 12 has a knob-like element 26 at the same location as the recess in the rotor hub 1. FIG. 8a is a plan view of the locking device. FIG. 8 b and c show said locking device in a side sectional view, in FIG. 8b the rotor blade 12 having a knob-like element 26 only on one side, while in FIG. 8c the rotor blade 12 has a knob-like element 26 on both sides of the cross-section through the rotor blade 12.

FIGS. 9a-c show a second embodiment of a locking device in a plan view and in two side sectional views, in FIG. 9b the rotor blade 12 having a knob-like element 26 only on one side, while in FIG. 9c the rotor blade 12 has a knob-like element 26 on both sides of the cross-section through the rotor blade 12. In the second embodiment shown in FIG. 9, the knob-like element 26 is arranged between the rotor axis 19 and the rotor blade axis 20. The recess 27 on the rotor hub 1 is designed as a hole in the rotor hub 1.

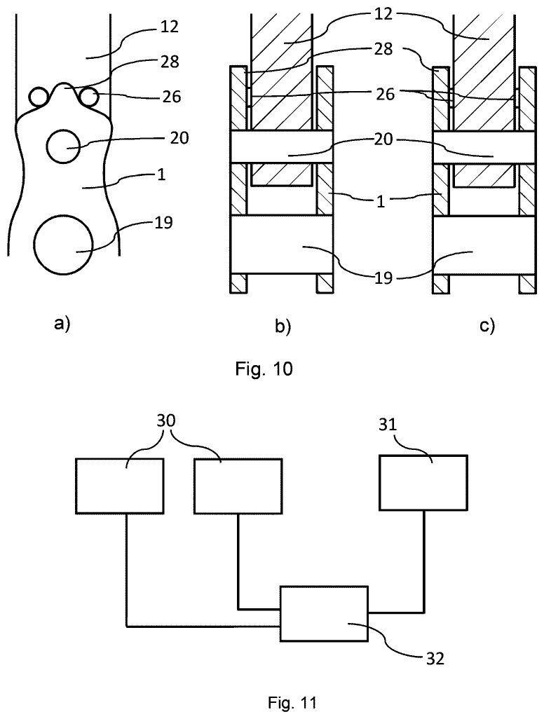

FIGS. 10a-c show a third embodiment of a locking device in a plan view and in two side sectional views. In FIG. 10b, the rotor hub 1 has a bulge 28 in the form of a narrow tapered end only on one side, while the rotor hub 1 in FIG. 10c has the bulge 28 in the form of a narrow tapered end on both sides of the cross-section through the rotor hub 1. The bulge 28 lies on a straight line which runs on the rotor hub 1 through the center of the rotor axis 19 and the rotor blade axis 20. When the rotor blade 12 is in the operating position, the rotor blade 12 has a knob-like element 26 on each side of the bulge 28 of the rotor hub 1.

FIG. 11 is a schematic representation of a part of an assembly 14, which includes sensors for detecting the rotor position 30 and/or the motor temperature 31. The sensors for detecting the rotor position 30 can be, for example, Hall sensors or optical sensors. The sensors 30, 31 can be connected to a controller 32 for the motor of the drive shaft 3 or to the controller 32 of the aircraft. The controller 32 can process further relevant signals and information for the operation of the aircraft.

The position sensors 30 can, for example, detect the position of a rotor drive such as an electric motor and can, for example, be integrated into the electric motor or motor. The position sensors 30 can also detect the position of the drive shaft 3 and/or the rotor hub 1 and/or the rotor blades 12. By means of the position sensors 30, for example in the case of a fixed-wing aircraft, the rotor blades 12 can be brought into a horizontal position or stopped in a horizontal position during landing. This allows the rotor blades 12 to be protected from contact with the ground during landing. In this case, the rotor blades 12 must be stopped in a certain predetermined position. In this case, the O-ring 7 in the rotor hub 1 prevents the rotor hub 1 from becoming detached from the drive shaft 3 due to a rapid, abrupt braking of the drive shaft 3 in the specific position. The temperature sensor 31 can also provide information on the operating status of the motor, for example, which can be used for example to determine whether landing the aircraft is appropriate or necessary.

What is claimed is:

1. A rotor hub for propeller-driven aircraft, comprising a hole for receiving a drive shaft, the hole comprising an internal thread which is designed to interact with an external thread of the drive shaft and to detachably connect the rotor hub to the drive shaft, wherein the hole has an annular groove for receiving an O-ring which is suitable for inhibiting a relative movement between the rotor hub and the drive shaft.

2. The rotor hub according to claim 1, wherein the hole has a first hole section, the first hole section comprising the annular groove, and wherein the hole has a second hole section, the second hole section comprising the internal thread, and the internal diameter of the first hole section being larger than the nominal diameter of the internal thread.

3. The rotor hub according to claim 1, wherein the annular groove and the internal thread are designed to be spaced apart from one another in the axial direction.

4. The rotor hub according to claim 1, wherein the hole has a screw-in direction and wherein the annular groove is arranged in front of the internal thread in the screw-in direction.

5. The rotor hub according to claim 1, wherein the rotor hub is a propeller hub and has at least one receiving element for fastening a rotor blade.

6. An assembly comprising a rotor hub according to claim 1, and further comprising; an O-ring, the O-ring being arranged in the annular groove; a drive shaft, the drive shaft having a drive shaft axis and an external thread which is designed to interact with the internal thread of the rotor hub and to detachably connect the drive shaft to the rotor hub.

7. the assembly according to claim 6, wherein the annular groove of the rotor hub has a width and a depth and wherein the O-ring is designed and positioned in the annular groove in such a way as to bring the rotor hub and the drive shaft into frictional contact when installed.

8. The assembly according to claim 6, wherein the drive shaft comprises a functional section which forms a clearance fit or a transition fit with the first hole section of the rotor hub.

9. The assembly according to claim 6, wherein the rotor hub has a rotor axis and a rotor hub rotational direction about the rotor axis corresponding to the driven state, and wherein the thread direction of the rotor hub and drive shaft is designed such that when accelerated by a drive system in the rotor hub rotational direction, the rotor hub is tightened on the drive shaft.

10. The assembly according to claim 6, wherein the O-ring consists of a polymer.

11. The assembly according to claim 6, further comprising at least one rotor blade which is mounted in the receiving element so as to be rotatable about a rotor blade axis, the rotor blade axis being aligned substantially parallel to the drive shaft axis, the rotor blade having an operating position and the rotor blade in the operating position being aligned substantially radially to the drive shaft axis and radially to the rotor blade axis, and the rotor blade having a storage position and the rotor blade in the storage position being rotated about the rotor blade axis relative to the operating position.

12. The assembly according to claim 11, wherein a locking device is provided to hold the rotor blades in the operating position or in the storage position.

13. The assembly according to claim 6, wherein the rotor blade has a first rotor direction of rotation about the rotor blade axis and a second rotor direction of rotation opposite the first rotor direction of rotation, and wherein the rotor blade has an end near the rotor hub and an end remote from the rotor hub, and the rotor hub has a stop surface which interacts with the end of the rotor near the rotor hub in such a way that a deflection of the rotor blade in the second rotor direction of rotation is limited to an angle a of at most 90° relative to the operating position of the rotor blade.

14. The assembly according to claim 6, wherein the stop surface is designed such that a deflection of the rotor blade in the second rotor rotation direction of at least 75° relative to the operating position of the rotor blade is permitted.

15. The assembly according to claim 6, wherein the assembly comprises at least one rotor position sensor for detecting the rotor position and/or a temperature sensor for detecting the motor temperature.

16. The assembly according to claim 13, wherein the angle a is at most 85°.

17. The assembly according to claim 14, wherein deflection of the rotor blade in the second rotor rotation direction is at least 80° relative to the operating position of the rotor blade is permitted.
